(19) United States
(12) Patent Application Publication
(10) Pub. No.: US 2020/0282957 A1
(43) Pub. Date: Sep. 10, 2020

(54) ONBOARD MOTOR-VEHICLE WASHING APPARATUS AND METHOD FOR OPERATION THEREOF

(71) Applicant: Röchling Automotive SE & Co. KG, Mannheim (DE)

(72) Inventors: Alessandro Iviglia, Tesimo (IT); Stefano Dalpez, Male (IT)

(21) Appl. No.: 16/723,328

(22) Filed: Dec. 20, 2019

(30) Foreign Application Priority Data
Mar. 4, 2019 (DE) 10 2019 105 468.0

(51) Int. Cl. B60S 1/52; B60S 1/50; B60S 1/54; B60S 1/48

(52) U.S. Cl. CPC B60S 1/52; B60S 1/481; B60S 1/54; B60S 1/50

(57) ABSTRACT

A motor-vehicle washing apparatus for cleaning a vehicle portion having a container for stocking liquid, a nozzle for delivering liquid, a first conveying conduit that proceeds from the container to the nozzle, a first conveying apparatus that is arranged to bring about, in the first conveying conduit, a flow of liquid from the container to the nozzle, a second conveying conduit that to direct a fluid that differs from the liquid from an aspiration location toward the nozzle, a second conveying apparatus that is arranged to bring about, in the second conveying conduit, a flow of the fluid toward the nozzle, a control apparatus for controlling the operation of the first and second conveying apparatus, the first and second conveying conduits being constituted, along a common conveying conduit portion located closer to the nozzle, by a common conveying conduit apparatus, so that the liquid and the fluid flow, at least in the common conveying conduit portion, in the same conveying conduit apparatus, the fluid is a gas, so that a two-phase flow flows upon simultaneous conveyance of the liquid and the gas in the common conveying conduit portion.

This application claims priority in German Patent Application DE 10 2019 105 468.0 filed on Mar. 4, 2019, which is incorporated by reference herein.

The present Application relates to a motor-vehicle washing apparatus, carryable on a motor vehicle, for cleaning a vehicle portion by applying a liquid onto the vehicle portion, the washing apparatus encompassing:
a container for stocking the liquid;
a nozzle for delivering liquid;
a first conveying conduit that proceeds from the container to the nozzle and is embodied to direct liquid from the container to the nozzle;
a first conveying apparatus that is arranged and embodied to bring about, in the first conveying conduit, a flow of liquid from the container to the nozzle;
a second conveying conduit that is embodied to direct a fluid that differs from the liquid from an aspiration location toward the nozzle;
a second conveying apparatus that is arranged and embodied to bring about, in the second conveying conduit, a flow of the fluid that differs from the liquid toward the nozzle; and
a control apparatus for controlling the operation of the first and the second conveying apparatus,
   the first and the second conveying conduit being constituted, along a common conveying conduit portion located closer to the nozzle, by a common conveying conduit apparatus, so that the liquid and the fluid that differs from it flow, at least in the common conveying conduit portion, in the same conveying conduit apparatus. The present invention furthermore relates to a method for operating a motor-vehicle washing apparatus of this kind.

### BACKGROUND OF THE INVENTION

Onboard motor-vehicle washing apparatuses of this kind are known on motor vehicles as a windshield washing system for the windshield and the rear window, and as a headlight washing system for the headlights, of a motor vehicle. The present Application proceeds from DE 10 2007 046 121 A1, which discloses a motor-vehicle washing apparatus of the kind recited initially which comprises two containers for applying two different fluids through the nozzle onto the vehicle portion that is to be cleaned. Selectably, only fluid from one of the two containers can be conveyed to and through the nozzle in order to apply that fluid onto the vehicle portion, or both fluids furnished in the two containers can be conveyed and delivered simultaneously as a mixed fluid.

The apparatus known from DE 10 2007 046 121 A1 serves, as evidenced by its exemplifying embodiment, to stock cleaning liquid in one container and a deicing liquid in the other container.

DE 10 2007 046 121 A1 recites liquids as the usual instance of different stocked fluids, but also mentions the possibility of conveying gases or aerosols through the two conveying conduits to the nozzle. DE 10 2007 046 121 A1 does not mention a mixture of fluids in different aggregate states. As compared with the possibility (merely mentioned) of conveying different aerosols in the two conveying conduits, utilization of a spray nozzle, and atomization by the spray nozzle of the liquid conveyed to the nozzle, are preferred, so that the conveyed liquid exists as an aerosol after passing through the nozzle.

One problem with the known motor-vehicle washing apparatuses is operation thereof at cold winter temperatures, when the atmosphere surrounding the motor vehicle having the motor-vehicle washing apparatus is at a temperature of less than 0° C. or even considerably below 0° C. Liquid residues that adhere to the nozzle after the most recent application of liquid onto the vehicle portion then often freeze, clog the nozzle, and thus prevent further use thereof. This is problematic especially while the motor vehicle is being driven, since the nozzle is then additionally cooled convectively by the wind blast.

To counteract this freezing, DE 10 2007 046 121 A1 proposes either to occasionally convey deicing liquid through the nozzle, or to mix deicing liquid into the cleaning liquid and thereby to lower its freezing point.

On the one hand, this only partly eliminates the risk of freezing, since even when the freezing point of the liquid mixture is lowered, the temperature can fall below the freezing point if external conditions are sufficiently cold.

On the other hand, the deicing liquid involves the use of an additional chemical that is sooner or later carried by rain into the environment from the vehicle portion onto which it is applied. Environmentally acceptable deicing liquids do exist. From an environmental standpoint, however, it is even better not to use any deicing liquid than to use an environmentally acceptable deicing liquid.

It is furthermore known to heat, in the container, a liquid that is to be applied through the nozzle onto a vehicle portion, in order to prevent it from freezing.

This too prevents the nozzle from freezing only to a limited extent, since on the one hand the liquid can be heated in the container only to a specific limit temperature and cools off again on the way to the nozzle. On the other hand, liquid residues remaining on the nozzle can freeze in the usual way after being cooled sufficiently.

Heatable spray nozzles, which are also known, are fault-prone. In addition, regions located on the exterior of the nozzle cannot always be heated, by a heating device in the interior of the nozzle, to the extent that would be necessary to successfully counteract cold external conditions.

### SUMMARY OF THE INVENTION

An object of the present invention is therefore to furnish a technical teaching that reliably enables environmentally benign cleaning of a vehicle portion by liquid application.

This object is achieved by the present invention by way of a motor-vehicle washing apparatus of the kind recited initially in which the fluid that differs from the liquid is a gas, so that a two-phase flow flows upon simultaneous conveyance of the liquid and the gas in the common conveying conduit portion.

It has been found that as a result of the use of a two-phase mixture, the quantity of liquid to be conveyed per unit time through the nozzle in order to clean the vehicle portion can be reduced, for the same cleaning performance, compared with a solely liquid single-phase flow. The quantity of liquid that must be used in order to clean the vehicle portion can thus be decreased, for a cleaning result that is otherwise the same.

The reason for the savings in liquid to be conveyed per unit time, which in the present case is preferably a cleaning liquid, is presumably the improvement, due to the two-phase flow, in the atomization of the liquid upon passage through the nozzle. The vehicle portion to be cleaned can thus be wetted more uniformly by the liquid than it can with a solely liquid single-phase flow.

Thanks to the gas phase flowing along with the liquid, less liquid also remains adhering to the nozzle, after operation of the motor-vehicle washing apparatus for cleaning a vehicle portion, than in the case of a solely liquid single-phase flow, so that as a result of the two-phase flow made up of gas and liquid, not only can the quantity of liquid to be utilized per unit time be lowered for an identical cleaning result, but the risk of freezing and thus clogging of the nozzle can additionally be reduced.

Firstly the quantity of liquid to be utilized per unit time is reduced, and secondly the risk of freezing of the nozzle subsequently to a conveying operation is reduced, without the use of a deicing substance or a heating apparatus in the container and/or conduit and/or nozzle.

The reduction in the quantity of liquid required creates further freedom for the motor vehicle designer: on the one hand, for a predefined number of nozzles supplied from a container, the capacity of the container can be reduced. It is then therefore possible to use a smaller container that occupies less space in the motor vehicle, without thereby degrading the cleaning performance of the motor-vehicle washing apparatus. On the other hand, for a predefined capacity of the container, the number of liquid delivery locations, and thus the number of nozzles supplied from the container, can be increased.

The latter is advantageous for modern motor vehicles that, in addition to a windshield and rear window and headlights, i.e. headlight covers, comprise further vehicle portions that require cleaning, for example camera lenses or covers thereof, e.g. of parking assistance cameras; radar sensors for automatically controlling the spacing of the relevant motor vehicle; and so forth. As the number of sensors used on the vehicle increases, the number of vehicle portions to be cleaned regularly, especially in winter, also increases.

The second conveying apparatus can advantageously encompass a gas compressor for conveying the gas. Said compressor is preferably a continuously operating rotary gas compressor, so that conveyance of gas in the second conveying conduit can be maintained even over long periods of time.

The gas aspiration location on the second conveying conduit is preferably located outside the container, and can thus be arranged almost anywhere in the motor vehicle, as long as gas delivery, preferably air delivery, is ensured.

In an application instance that is of particularly simple configuration and is therefore preferred, the second conveying apparatus can also be the first conveying apparatus.

This is possible when gas is not simply mixed by the second conveying apparatus into the liquid otherwise conveyed by the first conveying apparatus, but when the gas flow brought about by the second conveying apparatus causes the conveying and motion of the liquid in the first conveying conduit.

This can be achieved physically, for example, by exploiting the known Venturi effect. Provision can be made for this purpose that the first conveying conduit opens at an opening location into the second conveying conduit, the second conveying conduit having a Venturi portion at the opening location so that at the opening location, liquid is conveyable by gas that is flowing through the Venturi portion, as a result of the Venturi effect, out of the container to the nozzle.

Since the law of energy conservation also applies to flowing compressible fluids (i.e. gases), the sum of the pressure energy, kinetic energy, and gravitational potential energy must be constant for a gas flow as well. If the gravitational potential energy is ignored, since it does not change appreciably in a motor vehicle, the sum of the kinetic energy and pressure energy for the flow of a gas along a flow path is constant. The static pressure of the gas therefore decreases with increasing flow velocity.

As gas flows over the opening location of the first conveying conduit in which the liquid is not flowing, the elevated dynamic pressure (kinetic pressure) of the flowing gas therefore causes its static pressure with respect to atmospheric pressure to decrease, so that a gas space, kept at atmospheric pressure, above the liquid level in the container conveys liquid along the first conveying conduit into the gas flow, where it is entrained by the flowing gas. This effect can be further intensified by the fact that the opening location is arranged at a constriction of the Venturi portion, having a smaller flow cross section than before and after it in a flow direction, where the flow velocity of the gas along the second conveying conduit is even higher than immediately before or immediately after the constriction.

A separate first conveying apparatus for conveying the liquid can thus be eliminated, resulting in a particularly cost-effective motor-vehicle washing apparatus.

If particularly exact metering of the liquid and gas is desired, however, it is advantageous if a first conveying apparatus that is separate from the second conveying apparatus, and is capable of conveying the liquid in the first conveying conduit independently of the presence of a gas flow, is provided for conveying the liquid in the first conveying conduit. In order to increase the metering accuracy of the motor-vehicle washing apparatus, the first conveying apparatus can therefore encompass or be a liquid pump. The pump is preferably a continuously conveying pump having a rotating conveying component, in order to minimize a pulsating liquid delivery that is typically of pistons that move back and forth.

To increase the metering accuracy further, at least one valve arrangement can be arranged in the conveying conduit arrangement made up of the first and second conveying conduit including the common conveying conduit portion, by way of which valve arrangement the conveying conduit comprising the respective valve arrangement can be opened up for flow passage or blocked to prevent flow passage, depending on the operating state of the valve arrangement.

This valve arrangement can be a mixing valve arrangement at which the first and the second conveying conduit are brought together to constitute the common conveying conduit portion, the flowthrough-capable cross sections of the valve portions of such a mixing valve arrangement which are associated with the first and with the second conveying conduit preferably being adjustable independently of one another, so that a quantity and a mixing ratio of gas and liquid in the two-phase flow in the common conveying conduit portion can be adjusted within the widest possible limits.

Additionally or alternatively, however, a valve arrangement can also be arranged respectively in the first conveying conduit and/or in the second conveying conduit and/or in the common conveying conduit portion, so that the flow of liquid in the first conveying conduit and/or a flow of gas in the second conveying conduit and/or the two-phase flow in the common conveying portion can be selectably interrupted or enabled.

The valve arrangement can ensure, in addition to operation of the conveying apparatus, very exact metering of the liquid and/or the gas.

The gas is preferably air, although it does not need to be air. As already discussed above, the liquid is preferably a cleaning liquid. It can encompass water that can be mixed with surfactants and/or alcohol and the like.

The aforesaid at least one valve arrangement has at least two operating states, namely an opened operating state in which a conduit in which the valve arrangement is arranged is opened up for flow passage, and a blocked operating state in which the conduit is blocked to prevent flow passage.

The valve arrangement is preferably an electrically controllable valve arrangement so that it can be operated, and also controlled, as exactly as possible using the electrical energy supply system present in any case on the motor vehicle. For particularly exact metering of gas and/or liquid, the valve arrangement can be signal-transferringly coupled to the control apparatus, so that the operating state of the valve arrangement is modifiable by the control apparatus.

The possibility of conveying both gas and liquid through the nozzle results in particularly advantageous possibilities for implementing freeze protection for the nozzle. For example, the nozzle and the common conveying conduit portion located upstream from the nozzle in a conveying direction can be flushed with only gas for a predeterminable or predetermined time period after liquid has been conveyed, in order to remove liquid residues as comprehensively as possible from the common liquid conduit portion and from the nozzle. According to an advantageous refinement of the present Application, the control apparatus is therefore embodied to blow only gas through the nozzle after an intentional delivery of liquid through the nozzle.

For controlled blowing of only gas through the nozzle, it is particularly advantageous if, upstream from the common conveying conduit portion, at least the first liquid conduit is blockable by an aforesaid valve arrangement to prevent flow passage, so that no liquid can be entrained by the gas flow in the second conveying conduit, and thus also in the common conveying conduit portion, as only gas is blown through the nozzle. Particularly thorough removal of liquid from the nozzle and from the common liquid conduit portion can thereby be achieved.

This is also possible because air, constituting the preferred gas in the second conveying conduit, does not need to be stocked in a container but can be taken from the atmosphere, and is thus available de facto in unlimited fashion.

The aforementioned object is therefore also achieved by a method for operating a motor-vehicle washing apparatus encompassing the following steps:
providing an operating state in which the first and the second conveying conduit are flowthrough-capable as far as the nozzle;
operating the first and the second conveying apparatus and thereby simultaneously conveying both liquid and gas through the common conveying conduit portion to and through the nozzle;
terminating the conveying of liquid;
after the conveying of liquid has ended: conveying only gas through the common conveying conduit portion and through the nozzle for a predetermined time period.

The conveying of liquid can be terminated by shutting off the first conveying apparatus and/or by establishing the blocking operating state of a valve arrangement arranged in the first conveying conduit. That valve arrangement is then arranged in a portion of the first conveying conduit, which is arranged upstream from the common conveying conduit portion in a conveying direction.

The provision of the operating state can also be merely a provision of the motor-vehicle washing apparatus, if the latter does not comprise a valve arrangement. If it does comprise a valve arrangement, the flowthrough-capable operating state is provided by the fact that the at least one valve arrangement that is present is shifted into its open operating state so that the associated conveying conduit is flowthrough-capable.

The aforementioned object is also achieved by a motor vehicle having a motor-vehicle washing apparatus as described and refined above, the vehicle portion onto which the motor-vehicle washing apparatus applies liquid being a windshield and/or a headlight and/or a vehicle sensor and/or a camera lens.

Because headlights and camera lenses can be covered by a transparent cover in order to protect them from external influences, for purposes of the present Application such a cover is part of the apparatus covered by it, i.e., for example, part of the headlight and/or part of the camera lens.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWINGS

The invention may take physical form in certain parts and arrangement of parts, a preferred embodiment of which will be described in detail and illustrated in the accompanying drawing which forms a part hereof and wherein:

FIG. 1 schematically depicts a motor vehicle having an embodiment according to the present invention of a motor-vehicle washing apparatus of the present Application.

### DESCRIPTION OF PREFERRED EMBODIMENTS

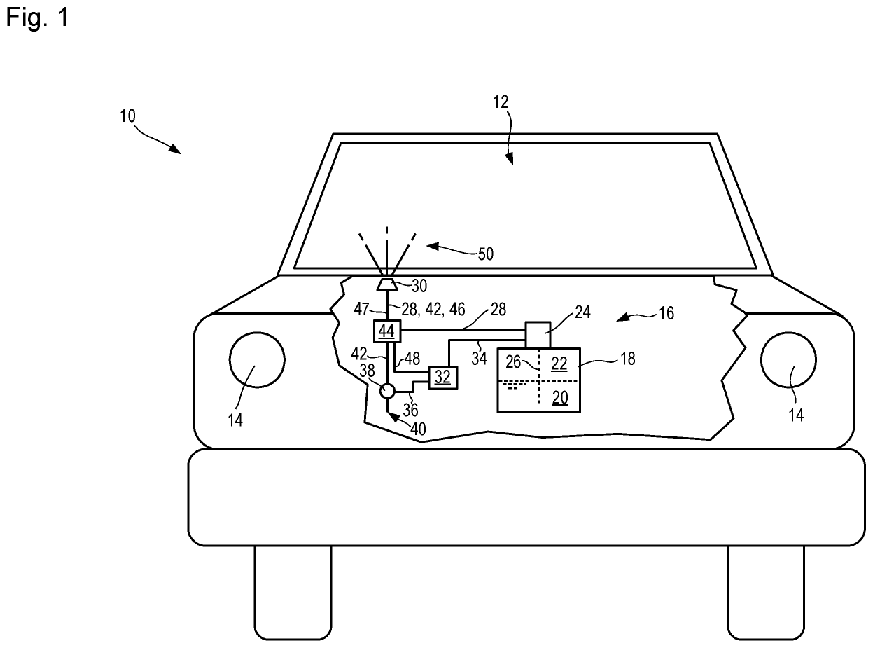

Referring now to the drawings wherein the showings are for the purpose of illustrating preferred and alternative embodiments of the invention only and not for the purpose of limiting the same, in FIG. 1, a motor vehicle is labeled in general with the number 10. The motor vehicle comprises vehicle portions to be cleaned, for example a windshield 12 and headlights 14. This list is not exhaustive.

Motor vehicle 10 has for this purpose a motor-vehicle washing apparatus 16 that is arranged in or on motor vehicle 10 for motion together with it.

Washing apparatus 16 encompasses a container 18 in which a cleaning liquid 20 is received. Container 18 is permanently vented in a manner known per se via a venting tube (not shown), so that a gas space 22 located above cleaning liquid 20 is always at atmospheric pressure.

A conveying pump 24, constituting a first conveying apparatus, can withdraw cleaning liquid from the container via an immersion tube 26 and convey it in a first conveying conduit 28 from container 20 to a nozzle 30. The conveying operation of conveying pump 24 is controlled by a control apparatus 32 that is coupled via an instruction lead 34 to conveying pump 24 in order to convey cleaning liquid 20 out of container 18.

Control apparatus 32 is connected via a further instruction lead 36 to a gas compressor 38 that can aspirate air, constituting a preferred gas, from an aspiration location 40 at an aspiration end of a second conveying conduit 42 outside container 18 and also convey it to nozzle 30.

First conveying conduit 28 and second conveying conduit 42, which can be embodied, for example, as a hose conduit or tube conduit, meet at a mixing valve arrangement 44 from which first and second conveying conduits 28, 42 proceed in a common conveying conduit portion 46 to nozzle 30. Common conveying conduit 46 is constituted by a common conveying conduit apparatus 47, for example a tube or hose.

Mixing valve arrangement 44 is likewise connected via an instruction lead 48 to control apparatus 32, which can itself in turn be coupled to a higher-order motor-vehicle control device.

Control apparatus 32 is embodied to operate liquid conveying pump 24 and gas compressor 38 simultaneously in order to simultaneously convey cleaning liquid 20 via first conveying conduit 28, and air via second conveying conduit 42, to nozzle 30. Control apparatus 32 can establish the mixing ratio of gas and air, and their quantity, via instruction lead 48, by adjusting mixing valve arrangement 44, for example by modifying flowthrough-capable cross sections of flowthrough openings, located in the mixing valve arrangement, for first conveying conduit 28 on the one hand and for second conveying conduit 42 on the other hand. In common conveying conduit portion 46, gas and cleaning liquid 20 flow as a two-phase flow to nozzle 30. From there, the two-phase flow is delivered as a spray mist 50 to windshield 12 in order to achieve, together with windshield wipers (not depicted), cleaning of windshield 12 in a manner known per se.

Several nozzles 30 for delivering cleaning liquid 20 onto windshield 12 are usually provided. It is sufficient for an explanation of the present invention, however, to describe only one nozzle 30 by way of example.

At least one nozzle for delivering cleaning liquid 20 and gas onto headlights 14 in order to clean them can also be provided respectively in the vicinity of headlights 14.

The advantage of motor-vehicle washing apparatus 16 consists on the one hand in the use of the two-phase flow of gas and cleaning liquid 20 to apply cleaning liquid 20 through nozzle 30 onto windshield 12, or in general onto a vehicle portion that is to be cleaned. Thanks to the use of a two-phase flow made up of gas and liquid, the quantitative ratios of which can moreover be adjusted exactly via mixing valve arrangement 44, cleaning liquid 20 can be more intensely atomized at nozzle 30, and consequently can be applied more evenly onto the vehicle portion that is to be cleaned, than would occur only as a result of the passage of a single-phase liquid flow through the nozzle. With a single-phase flow, that region of the vehicle portion to be cleaned which is most difficult for cleaning liquid to access determines how much cleaning liquid must be delivered during a cleaning operation. As a rule, with sufficient application onto the most poorly accessible vehicle portion, a quantity that is far greater than necessary is applied onto the easily accessible regions. The same cleaning effect can thus be achieved with a smaller quantity of cleaning liquid 20.

For the same cleaning performance, it is thus possible with a predetermined container 18 to supply, as compared with the existing art, a larger number of nozzles with a two-phase gas/cleaning liquid flow; or, for a predetermined number of nozzles 30, it is possible to use a container 18 that has a smaller capacity and requires less installation space as compared with the existing art.

For freeze protection, control apparatus 32 is particularly advantageously embodied to completely block flow passage through first conveying conduit 28, by means of mixing valve arrangement 44, after operating liquid 20 has been conveyed through conveying conduit 28, and for a predetermined time period to convey only gas by way of gas compressor 38 into second conveying conduit 42 to nozzle 30, and to blow gas through nozzle 30 for the predetermined time period. Cleaning liquid 20 can thereby be removed from common conveying conduit portion 46 and from nozzle 30, so that even in cold weather, after a conveying operation no cleaning liquid 20 remains on nozzle 30, or the quantity is not sufficient that it might freeze and clog the nozzle.

A heating apparatus on nozzle 30 and/or in container 18 and/or on common conveying conduit portion 46 can thus be omitted, thereby further simplifying the construction of motor-vehicle washing apparatus 16.

The nozzle is preferably a static nozzle having no moving components.

Independently of the exemplifying embodiment depicted in FIG. 1, the motor-vehicle washing apparatus of the present Application very generally is preferably devoid of a heating apparatus.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A motor-vehicle washing apparatus for cleaning a vehicle portion by applying a liquid onto the vehicle portion, the washing apparatus encompassing:
a container for stocking an associated liquid;
a nozzle for delivering the associated liquid;
a first conveying conduit that proceeds from the container to the nozzle and is embodied to direct the associated liquid from the container to the nozzle;
a first conveying apparatus that is arranged and embodied to bring about, in the first conveying conduit, a flow of the associated liquid from the container to the nozzle;
a second conveying conduit that is embodied to direct an associated fluid that differs from the associated liquid from an aspiration location toward the nozzle;
a second conveying apparatus that is arranged and embodied to bring about, in the second conveying conduit, a flow of the associated fluid that differs from the associated liquid toward the nozzle; and
a control apparatus for controlling the operation of the first and the second conveying apparatus,
the first and the second conveying conduit being constituted, along a common conveying conduit portion located closer to the nozzle, by a common conveying conduit apparatus, so that the associated liquid and the associated fluid that differs from the associated liquid flow, at least in the common conveying conduit portion, in the same conveying conduit apparatus,
wherein the associated fluid that differs from the associated liquid is an associated gas, so that a two-phase flow flows upon simultaneous conveyance of the associated liquid and the associated gas in the common conveying conduit portion.

12. The motor-vehicle washing apparatus according to claim 11, wherein the second conveying apparatus encompasses a gas compressor.

13. The motor-vehicle washing apparatus according to claim 12, wherein the second conveying apparatus is also the first conveying apparatus.

14. The motor-vehicle washing apparatus according to claim 13, wherein the first conveying conduit opens at an opening location into the second conveying conduit, the second conveying conduit having a Venturi portion at the opening location so that at the opening location, the associated liquid is conveyable as a result of the Venturi effect out of the container to the nozzle.

15. The motor-vehicle washing apparatus according to claim 11, wherein the first conveying apparatus is a liquid pump.

16. The motor-vehicle washing apparatus according to claim 11, wherein a valve arrangement is arranged in at least one of the first conveying conduit and the second conveying conduit, by way of which arrangement the conveying conduit comprising the valve arrangement can be opened up for flow passage or blocked to prevent flow passage, depending on the operating state of the valve arrangement.

17. The motor-vehicle washing apparatus according to claim 16, wherein the valve arrangement is signal-transferringly coupled to the control apparatus, so that the operating state of the valve arrangement is modifiable by the control apparatus.

18. The motor-vehicle washing apparatus according to claim 11, wherein the control apparatus is embodied to blow only the associated gas through the nozzle after an intentional delivery of the associated liquid through the nozzle.

19. A method for operating a motor-vehicle washing apparatus according to claim 11, encompassing the following steps:
providing an operating state in which the first and the second conveying conduit are flowthrough-capable as far as the nozzle;
operating the first and the second conveying apparatus and thereby simultaneously conveying both the associated liquid and the associated gas through the common conveying conduit portion to and through the nozzle;
terminating the conveying of the associated liquid;
after the conveying of the associated liquid has ended: conveying only the associated gas through the common conveying conduit portion for a predetermined time period.

20. The method according to claim 19, wherein the motor-vehicle washing apparatus includes a valve arrangement arranged in at least one of the first conveying conduit and the second conveying conduit, by way of which arrangement the conveying conduit comprising the valve arrangement can be opened up for flow passage or blocked to prevent flow passage, depending on the operating state of the valve arrangement.

21. A motor vehicle having a motor-vehicle washing apparatus according to claim 11, the vehicle portion onto which the motor-vehicle washing apparatus applies the associated liquid being at least one of a windshield, a headlight, a vehicle sensor and a camera lens.
